(19) United States
(12) Patent Application Publication
(10) Pub. No.: US 2020/0324719 A1
(43) Pub. Date: Oct. 15, 2020

(54) VEHICLE ISOLATION SWITCH FOR LOW VOLTAGE POWER SUPPLIES

(71) Applicant: Byton North America Corporation, Santa Clara, CA (US)

(72) Inventors: Abdulkareem Mahmoud, San Jose, CA (US); David Jiang, Santa Clara, CA (US)

(21) Appl. No.: 16/379,508

(22) Filed: Apr. 9, 2019

(51) Int. Cl. B60R 16/033; H01M 10/42; H02J 7/00; G05F 1/613; H04L 12/40

(52) U.S. Cl. CPC B60R 16/033; H01M 10/425; H02J 7/0063; H02J 7/0031; H04L 2012/40273; H04L 12/40; B60L 2210/10; H02J 2007/0067; H04L 2012/40215; G05F 1/613

(57) ABSTRACT

A power control system for a vehicle is disclosed. The power control system includes a first low voltage power supply, a second low voltage power supply, and an isolation switch. The first and second low voltage power supplies are capable of providing power to a plurality of subsystems. The isolation switch receives inputs from the first and second low voltage power supplies and selectively outputs power from either of the first and second low voltage power supplies to the plurality of subsystems on at least one power rail. The first low voltage power supply can be a 12-volt direct current-to-direct current (DC-DC) converter and the second low voltage power supply can be a rechargeable 12-volt battery. In case of a power failure to either of the DC-DC converter or rechargeable 12-volt battery, the isolation switch can isolate the failed power supply in the power control system and switch connection to the non-failed power supply to provide power to the subsystems.

### FIELD

Embodiments of the invention are in the field of electric power and control systems for vehicles using electric motors. More particularly, embodiments of the invention relate to a vehicle isolation switch for low voltage power supplies.

### BACKGROUND

Electric powered vehicles are gaining popularity due to its use of clean energy such as fully or partially autonomous driving (AD) vehicles. Electric powered vehicles can have multiple power supplies such as a high voltage power supply (main high-power supply) to drive an inductive motor rotating the wheels of the vehicle. Electric powered vehicles can also have low voltage power supplies (low-power supplies) to power electronic subsystems of the vehicle, e.g., subsystems for driving control, braking control, motor control, lighting and etc. Low-power supplies can include a direct current-to-direct current (DC-DC) converter coupled to the main high-power supply that converts high voltage from the main-power supply to a low voltage for the subsystems and can charge an auxiliary rechargeable low voltage battery that can also provide low voltage power to the subsystems when the DC-DC converter is off. In operation, when one of the low power supplies is off, the other is on to deliver low voltage power to the subsystems. If a power failure occurs to any of the low-power supplies such as, e.g., an electrical short, the electrical connections between the low-power supplies should be separated such that the electrical short does not prevent the other low-power supply from delivering power to the subsystems. For such an event, electric powered vehicles need to have safety measures in place to provide enough power to the electronic subsystems in order to allow the electric powered vehicle to be driven to a safe stop, either by human driver or autonomously. In case of such a power failure to a low power supply, electric powered vehicles should reach a safe stop within a short period of time from when a power failure occurs.

### SUMMARY

Embodiments and examples are disclosed of a power control system for a vehicle having first and second low voltage power supplies and an isolation switch receiving inputs from the first and second low voltage power supplies. The first and second low voltage power supplies are capable of providing power to a plurality of subsystems of the vehicle. The isolation switch is configured to selectively output power from either the first or second low voltage power supply to the plurality of subsystems on a least one power rail. For one example, each subsystem can include an electronic control unit (ECU) to control one or more components or functions of the vehicle and a transceiver coupled to an in-vehicle network such as a controller area network (CAN), local interconnect network (LIN), or an Ethernet network.

For one example, if one of the low voltage power supplies has a power failure to the subsystems, the isolation switch can select the other low voltage power supply as a power supply to power the subsystems to of the vehicle. For example, the isolation switch can isolate the failed low voltage power supply and provide a connection to the other low voltage power supply in order to maintain power to critical subsystems of the vehicle so that the vehicle can maintain operation and reach a safe stop while avoiding hazardous conditions. Such critical subsystems can include autonomous driving (AD), steering, braking, airbag, lighting or other subsystems needed to reach a safe stop.

For one example, the first low voltage power supply can be a 12-volt direct current-to-direct current (DC-DC) converter and the second low voltage power supply can be a rechargeable 12-volt battery. For one example, the isolation switch isolates the DC-DC converter from the rechargeable 12-volt battery if there is a power failure to the DC-DC converter and can switch connection of the plurality of subsystems to the rechargeable 12-volt battery. The isolation switch can also isolate the rechargeable 12-volt battery from the DC-DC converter if there is a power failure to the rechargeable 12-volt battery and can switch connection of the plurality of subsystems to the DC-DC converter. The DC-DC converter can receive power from a main high voltage power supply and recharge the rechargeable 12-volt battery.

For one example, the isolation switch includes one or more sensors, one or more power switches, and a micro-controller. The micro-controller is coupled to the one or more sensors and power switches. The micro-controller is configured to detect a power failure to the low voltage power supply by analyzing the output of the one or more sensors. In the event of detecting a power failure, the micro-controller can control one or more power switches to selectively output power from either the first low voltage power supply or the second low voltage power supply to output power to the subsystems. The micro-controller can also be coupled to a vehicle gateway that can also send messages to the isolation switch of a power failure. For one example, the switching of power between the low voltage power supplies can occur within, e.g., milliseconds, and before an internal capacitance storage is depleted. This allows power for the subsystems including the vehicle gateway to be maintained if power from the low voltage power supplies is temporarily disabled to the subsystems. In this way, the lag time for switching between low voltage power supplies does not affect operation of the subsystems or vehicle gateway.

For one example, the isolation switch can include a plurality of fuses such that each fuse corresponds to an output to one of the plurality of subsystems. The fuse can disconnect a corresponding subsystem from either the first low voltage power supply or the second low voltage power supply if current reaches or exceeds a threshold through the fuse. In this way, the isolation switch can use fuses to isolate faulty outputs to the subsystems without interfering with power supply to other subsystems during a power failure.

For one example, the isolation switch can be a single module with switches and fuses to optimize serviceability and avoid needing a separate fuse box for each low voltage power supply. By using the isolation switch disclosed herein, a single low-power system can be used instead of using multiple power systems to provide power from each low voltage power supply to the subsystems of the vehicle.

Other systems, devices, methods and vehicles are described.

### BRIEF DESCRIPTION OF THE DRAWINGS

The appended drawings illustrate examples and embodiments and are, therefore, exemplary and not considered to be limiting in scope.

FIG. 1A illustrates one example of a vehicle with an isolation switch for low voltage power supplies.

FIG. 1B illustrates one example of a network topology for the vehicle of FIG. 1A.

FIG. 2 illustrates one example block diagram of a power control system for a vehicle having an isolation switch.

FIG. 3A illustrates one example block diagram of detailed components for a power control system having an isolation switch with one power switch.

FIG. 3B illustrates another example block diagram of detailed components for a power control system having an isolation switch with two power switches.

FIG. 4 illustrates one example of a current table for the inputs and outputs of a power control system.

FIG. 5 illustrates one example flow diagram of an operation for an isolation switch.

FIG. 6A illustrates one example flow diagram of an operation for an isolation switch with one power switch.

FIG. 6B illustrates one example flow diagram of an operation for an isolation switch with two power switches.

FIG. 7 illustrates one exemplary block diagram of a vehicle network with interconnected subsystems to power rails.

### DETAILED DESCRIPTION

The following detailed description provides embodiments and examples of a power control system for a vehicle having an isolation switch for low voltage power supplies. For one example, the power control system includes a first low voltage power supply (e.g., a 12V DC-DC converter), a second low voltage power supply (e.g., a rechargeable 12V battery), and an isolation switch receiving inputs from the two low voltage power supplies. The first and second low voltage power supplies are capable of providing power to a plurality of subsystems of the vehicle on at least one power rail. The isolation switch is configured to selectively output power from either the first or second low voltage power supply to the plurality of subsystems on a least one power rail. The disclosed isolation switch allows for a single module and power system instead of needing separate modules and power control systems for each low voltage power supply to provide power to the subsystems. For one example, in the event of a power failure to a low voltage power supply, the vehicle can switch to another low voltage power supply and maintain power to critical subsystems so that the vehicle can maintain operation and reach a safe stop while avoiding hazardous conditions. Examples of critical subsystems can include autonomous driving (AD), steering, braking, airbag, lighting or other subsystems needed for an electric powered vehicle to reach a safe stop.

As set forth herein, various embodiments, examples and aspects will be described with reference to details discussed below, and the accompanying drawings will illustrate various embodiments and examples. The following description and drawings are illustrative and are not to be considered as limiting. Numerous specific details are described to provide a thorough understanding of various embodiments and examples. However, in certain instances, well-known or conventional details are not described to facilitate a concise discussion of the embodiments and examples. Although the following examples and embodiments can be directed to autonomous electric driving vehicles (AD vehicles), the power control system and isolation switch disclosed herein can be implemented for any type of electric vehicle needing redundant low-power voltages supplies to power subsystems of the vehicle.

### Exemplary Vehicle with Isolation Switch for Low Voltage Power Supplies

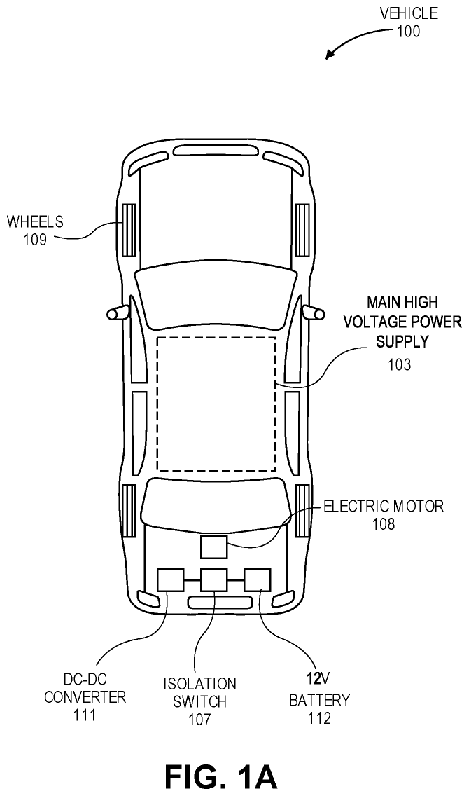

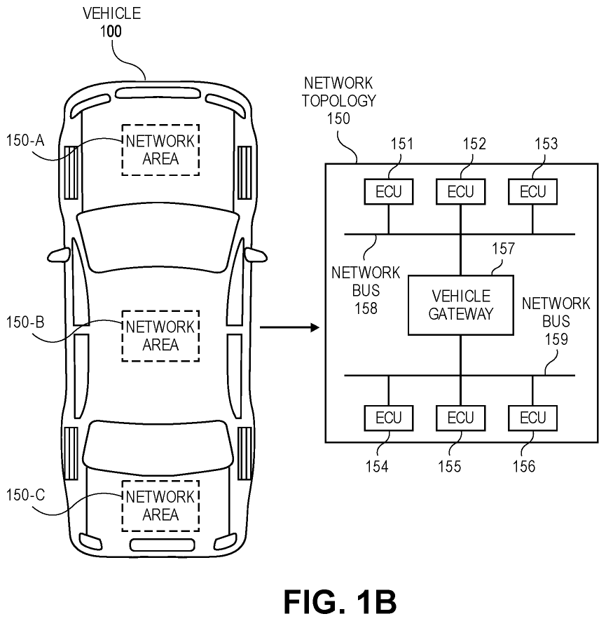

FIG. 1A illustrates one example of a vehicle 100 with an isolation switch 107 for low voltage power supplies such as DC-DC converter 111 and 12-volt (12V) battery 112. For one example, on the high voltage power side, vehicle 100 includes an electric motor 108 receiving power from the main high voltage power supply 103 to generate torque and turn wheels 109. Although vehicle 100 is shown with one electric motor 108 powered by main high voltage power supply 103 for a two-wheel drive implementation, vehicle 100 can have a second electric motor for a four-wheel drive implementation. In this example, electric motor 108 is located at the rear of vehicle 100 to drive back wheels 109 as a two-wheel drive vehicle. For other examples, another electric motor can be placed at the front of vehicle 100 to drive front wheels 109 as a front-wheel or four-wheel drive vehicle implementation.

Examples of electric motor 108 can include alternating current (AC) induction motors, brushless direct-current (DC) motors, and brushed DC motors. Exemplary motors can include a rotor having magnets that can rotate around an electrical wire or a rotor having electrical wires that can rotate around magnets. Other exemplary motors can include a center section holding magnets for a rotor and an outer section having coils. For one example, when driving wheels 109, electric motor 108 contacts with the main high voltage power supply 103 providing an electric current on the wire that creates a magnetic field to move the magnets in the rotor that generates torque to drive wheels 109.

For one example, main high voltage power supply 103 can be a 120V rechargeable battery to power electric motor 108 or other electric motors for vehicle 100. Examples of main high voltage power supply 103 can include lead-acid, nickel-cadmium, nickel-metal hydride, lithium ion, lithium polymer, or other types of rechargeable batteries. For one example, the main high voltage power supply 103 can be located on the floor and run along the bottom of vehicle 100. As a rechargeable battery, for one example, main high voltage power supply 103 can be charged by being plugged into an electrical outlet when vehicle 100 is not in operation. The location and number of high voltage rechargeable batteries is not limited to one and can be located throughout vehicle 100 in any location. For one example, vehicle 100 can be a hybrid, autonomous or non-autonomous vehicle or electric car.

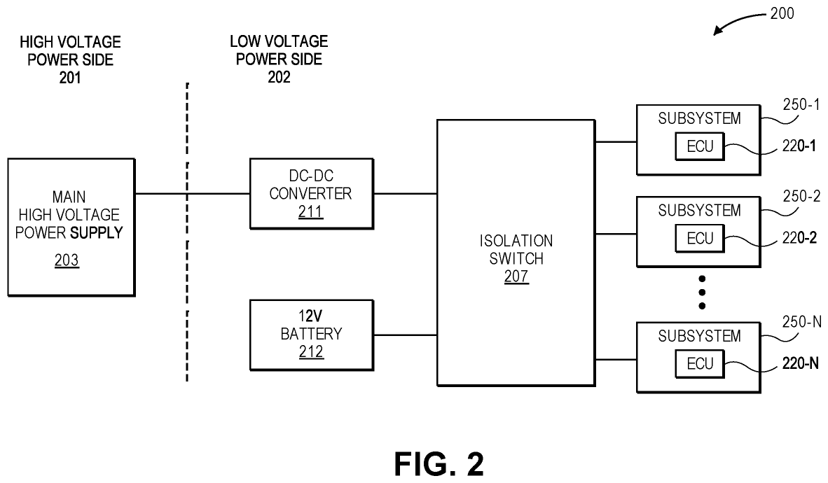

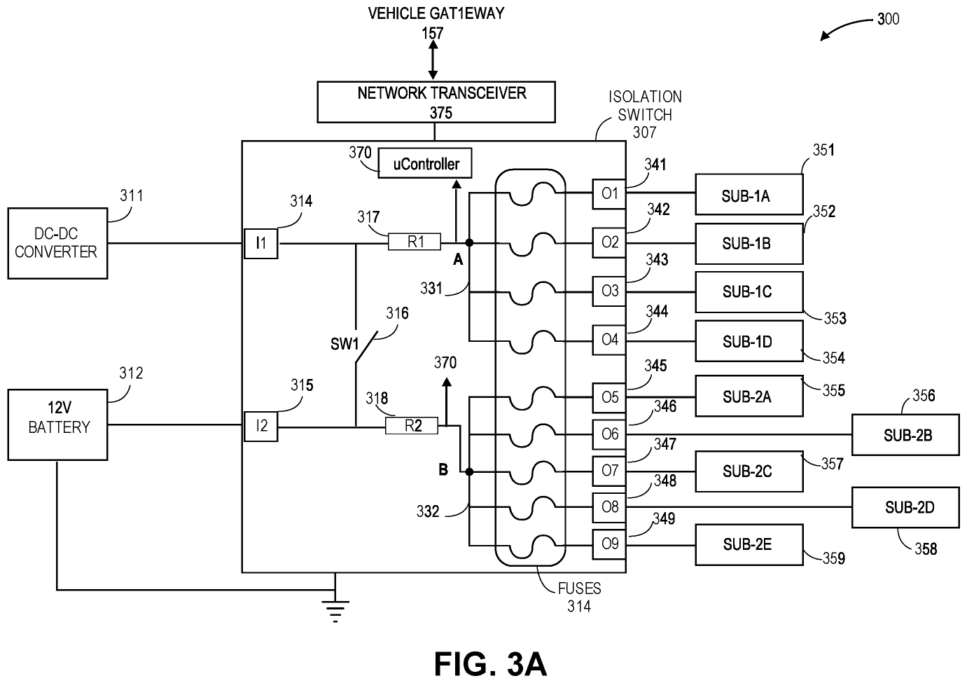

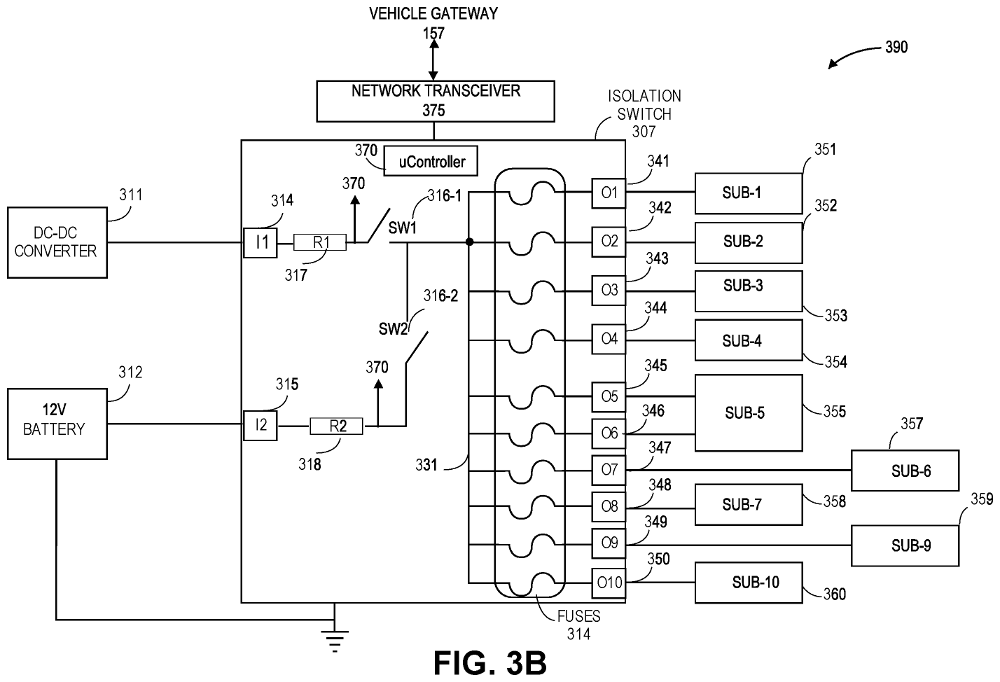

For one example, vehicle 100 can be configured to comply with automotive safety integrity level (ASIL) standards such as ISO 26262. For example, vehicle 100 can be configured to provide level 3 to 5 AD driving and in the event of failure of one of the low voltage power supplies. For such an event, vehicle 100 can provide enough low voltage power for the critical subsystems in order for vehicle 100 to be driven to a safe stop. For one example, on the low voltage power side, isolation switch 107 receives inputs from low voltage power supplies such as DC-DC converter 111 and 12V battery. Isolation switch 107 can be configured to selectively couple one of the inputs from either the DC-DC converter 111 or 12V battery to one or more outputs to power electronic subsystems within vehicle 100 as shown, e.g., in FIG. 2 (subsystems 250-1 to 250-N), FIG. 3A (subsystems 351-359), and FIG. 3B (subsystems 351-360). For one example, isolation switch 107 can be a single module within vehicle 100 maintaining power from redundant low voltage power supplies to subsystems of vehicle 100 in case of a power failure to the low voltage power supplies allowing vehicle 100 to reach a safe stop.

For one example, if a power failure occurs to DC-DC converter 111 that was powering subsystems of vehicle 100, isolation switch 107 can isolate and separate the DC-DC converter 111 and provide a connection to the 12V battery 112 as a power source for the electronic subsystems. In this way, power to critical subsystems (e.g., AD, steering, braking, airbag, lighting or other subsystems) can be maintained to drive vehicle 100 to a safe stop and location. Likewise, if the 12V battery 112 is providing power to the subsystems of vehicle 100 and it fails, isolation switch 107 can isolate and separate the failed 12V battery 112 and isolation switch 107 can make a connection to DC-DC converter 111 as the power source to power the subsystems of vehicle 100. For one example, in operation, isolation switch 107 can connect DC-DC converter 111 to 12V battery 112 such that the DC-DC converter 112 charges the 12V battery 112. If a power failure occurs to the DC-DC converter 111, isolation switch 107 can isolate and break the connection from DC-DC converter 111 with the subsystems and connect the subsystems to 12V battery 112 as a low voltage power supply.

FIG. 1B illustrates one example of a network topology 150 for vehicle 100 of FIG. 1A. Network topology 150 includes interconnected electronic control units (ECUs) 151-156 of for electronic subsystems of vehicle 100 by way of network busses 158 and 159. For one example, ECUs can be a micro-controller, system-on-chip (SOS), or any embedded system that can run firmware or program code stored in one or more memory devices or be hard-wired to perform operations or functions for controlling subsystems including respective components within vehicle 100. Although FIG. 1B shows three network areas including network areas 150-A, 150-B and 150-C, any number of network areas can be located throughout vehicle 100. Each network area can include any number ECUs interconnected by way of network topology 150.

For one example, each ECU can run firmware or code or be hard-wired to perform its function and control any number of electronic subsystems operating within vehicle 100. For example, ECUs in the front end such as network area 150-A can have ECUs controlling electronic components for headlights, power steering, parking, braking, engine controls etc. Network area 150-B in the mid-section of vehicle 110 can have ECUs controlling electronic subsystems for opening and closing door locks and other interior controls and the main high voltage power supply 103. Network area 150-C near the back end of vehicle 110 can have ECUs controlling electronic subsystems for tail lights, DC-DC converter 111, isolation switch 107, 12V battery and other related components. The ECUs in the different networking areas of vehicle 110 may need to communicate with each other by way of network topology 150 and network busses 158 and 159. Although two network busses are shown in FIG. 1B, any number of network busses may be used to interconnect the ECUs.

For one example, network topology 150 includes network or communication busses 158 and 159 interconnecting ECUs 151 through 156 and coupling the ECUs to a vehicle gateway 157. For one example, vehicle gateway 157 can include a micro-controller, central processing unit (CPU), or processor or be a computer and data processing system to coordinate communication on network topology 150 between the ECUs 151-156. For one example, vehicle gateway 157 interconnects groups (or networks) and can coordinate communication between a group of ECUs 151-153 with another group of ECUs 154-156 on busses 158 and 159. For one example, vehicle gateway 157 can communicate power failure and control information to isolation switch 107 to switch between low voltage power supplies such as DC-DC converter 111 and 12V battery 112. Vehicle gateway 157 can also have a wireless network connection to connect externally to the cloud or Internet and communicate external signals and data, e.g., global positioning system (GPS) signals and data. For one example, network topology 150 and busses 158 and 159 can support messaging protocols including Controller Area Network (CAN) protocol, Local Interconnect Protocol (LIN), and Ethernet protocol.

### Exemplary Power Control Systems with Isolation Switch

FIG. 2 illustrates one example block diagram of a power control system 200 for vehicle 100 having an isolation switch 207 to selectively provide power to a plurality of subsystems 250-1 to 250-N from low voltage power supplies such as DC-DC converter 211 or 12V battery 212. Vehicle gateway 157 can also be represented as one of the subsystems 250-1 to 250-N. Referring to FIG. 2, the high voltage power side 201 includes the main high voltage power supply 203 that powers an electric motor 108 of vehicle 100. The main high voltage power supply 203 can be a 120-volt rechargeable battery. For this example, the main high voltage power supply 203 is coupled to DC-DC converter 211 that can convert DC voltage from the main high voltage power supply (e.g., 120 volts) to a lower DC voltage such as 12-volts. On the low voltage power side 202, power control system 200 has two low voltage power supplies comprising of DC-DC converter 211 and 12V battery 212. For this example, the DC-DC converter 211 can charge 12V battery 212 by way of a connection through isolation switch 207.

For one example, isolation switch 207 is configured to control connections from DC-DC converter 211 and 12V battery 212 to selectively outputs power from either of the DC-DC converter 211 or 12B battery 212 to subsystems 250-1 to 250-N. Each of the subsystems 250-1 to 250-N can include respective ECUs 220-1 to 220-N to control functions in vehicle 100 such as, for example, autonomous driving (AD), steering control, airbag control, braking control and lighting control, which can be considered critical functions. Subsystems 250-1 to 250-N can include other ECUs to control other non-critical functions such as climate control etc. For one example, in operation, isolation switch 207 outputs power from DC-DC converter 211 to subsystems 250-1 to 250-N and can detect a power failure to DC-DC converter 211. If a power failure to DC-DC converter 211 is detected, isolation switch 207 can isolate DC-DC converter 211 in the power control system 200, and switch output power from the 12V battery 212 to subsystems 250-1 to 250-N. Isolation switch 211 can also return power back to DC-DC converter 211 to power the subsystems 250-1 to 250-N and charge 12V battery 212.

### Isolation Switch with One Switch Example

FIG. 3A illustrates one example block diagram of detailed components of a power control system 300 having an isolation switch 307 with one power switch SW1 316. For one example, SW1 316 can be a field effect transistor (FET) that can open or close a connection. Isolation switch 307 has an input I1 314 coupled to DC-DC converter 311 and an input I2 315 coupled to 12V battery 312. DC-DC converter 311 can be powered by a main high voltage power supply 203 and charge 12V battery 312. Transceiver 375 can be coupled to the vehicle gateway 157 by way of any type of vehicle network such as a controller area network (CAN), local interconnect network (LIN), or an Ethernet network.

For one example, within isolation switch 307, input I1 314 is coupled with a first sensing resistor R1 317 and SW1 316. The current from the first sensing resistor R1 can be received and sensed by the micro-controller (μcontroller) 370. The voltage across R1 or coupled to R1 can also be received by μcontroller 370. Input 12 315 is coupled with a second sensing resistor R2 318 and SW1 316. The current from the second sensing resistor R2 318 can be received and sensed by μcontroller 370 as well as the voltage across R12 or coupled to R2. The first sensing resistor R1 317 is coupled to a first power rail 331 at Node A and the second sensing resistor R2 318 is coupled to a second power rail 332 at Node B. Nodes A and B are coupled to fuses 314 which are connected to outputs O1-O9 (341-349). Fuses 314 can include smart fuses or resettable fuses if certain operating conditions are returned and breaks connections if current reaches or exceeds a threshold through the fuses. Each of the outputs O1-O9 are connected to respective subsystems 351-359, 362 and 372 to control functions within vehicle 100. For one example, the first power rail 331 at Node A is coupled to outputs O1-O4 (341-344) and the second power rail 332 at Node B is coupled to outputs O5-O9 (345-349).

For one example, outputs O1-O4 (341-344) are coupled to a first set of subsystems SUB-1A to SUB-1D (351-354) at Node A and outputs O5-O9 (345-359) are coupled to a second set of subsystems SUB-2A to SUB-2D (355-359) at Node B. For one example, the second set of subsystems SUB-2A to SUB-2D (355-359) can include back-up or redundant subsystems of the first set of subsystems SUB-1A to SUB-1D (351-354). For instance, during normal operation, the first set of subsystems SUB-1A to SUB-1D (351-354) are used to control functions within vehicle 100 and powered by DC-DC converter 311. If a power failure occurs to DC-DC converter 311, the isolation switch 307 can have the second set of subsystems SUB-2A to SUB-2D (355-359) control functions of vehicle 100 and powered by 12V battery 312. For one example, the subsystems SUB-1A to SUB-1D and SUB-2A to SUB-2D can represent subsystems to control functions in vehicle 100 such as front and rear braking, autonomous driving (AD), ignition control, steering, dynamic stability, motion or movement sensors, climate control and etc.

In operation, for one example, SW1 316 is closed (turned on) and DC-DC converter 311 charges 12V battery 312 by way of connection through SW1 316. For one example, when SW1 316 is closed, only the he first set of subsystems SUB-1A to SUB-1D (351-354) are used to control functions of vehicle 100 such that DC-DC converter 311 is providing low voltage power to subsystems SUB-1A to SUB-1D (351-354) at Node A. Although power is also supplied to Node B, the second set of subsystems SUB-2A to SUB-2D (355-359) can be turned off such that power by subsystems SUB-2A to SUB-2D is not being used.

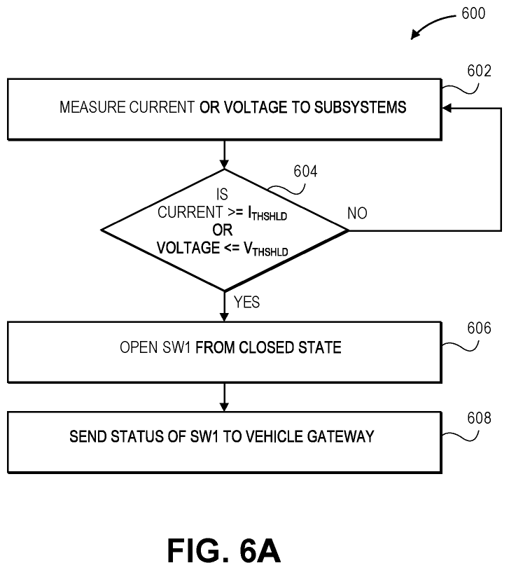

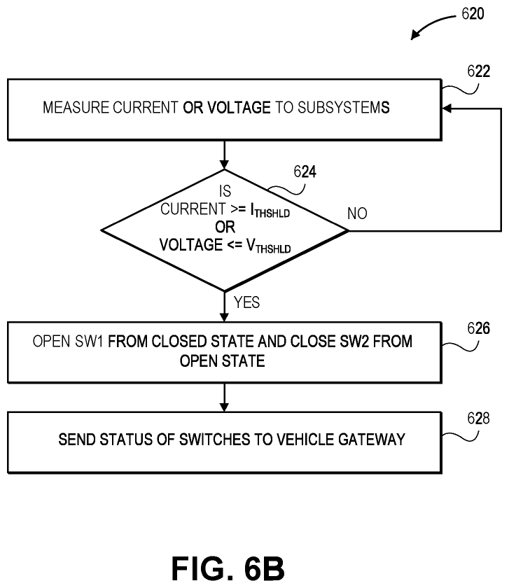

For one example, the μcontroller 370 can detect a power failure to DC-DC converter 311 if current passing through the first resistor R1 317 reaches or exceeds a threshold or a voltage across resistor R1 317 or at Node A reaches or is below a threshold as disclosed, e.g., in FIG. 6A. For other examples, vehicle gateway 157 can inform the μcontroller 370 that a power failure has occurred at DC-DC converter 311 by other components or sensors. In the event of a power failure to DC-DC converter 311, the μcontroller 370 can open SW1 316 (turned off) such that DC-DC converter 311 is isolated from the second power rail at Node B and no longer providing low voltage power to the first set of subsystems SUB-1A to SUB-1D (351-354) by DC-DC converter 311 being turned off or fuses 314 being broken for outputs O1-O4. When SW1 316 is open, the 12V battery 312 provides power to the outputs O5-O9 (345-349) and the second set of subsystems SUB-2A to SUB-2D (355-359) which are used to control functions of vehicle 100 during a power failure such that vehicle 100 can be driven to a safe stop. Additionally, if current surges through Node A at the outputs O1-O4 (341-344) on the first power rail 331 reaching or exceeding a threshold, fuses 314 corresponding to those outputs can open and break a connection to the corresponding subsystems. In this way, the connections to outputs O1-O4 (341-344) that are broken can be isolated from other outputs in the power control system 300.

For another example, 12V battery 312 can be the low voltage power supply supplying power to both power rails at nodes A and B through SW1 316 at outputs O1-O9 (341-349). And, if the μcontroller 370 detects current passing through the second sensing resistor R2 318 reaching or exceeding a threshold a voltage across resistor R2 318 or at Node B reaches or is below a threshold, the μcontroller 370 can open (turned off) SW1 316 and turn off the 12V battery 312 and allow power from DC-DC converter 311 to be used as the low voltage power supply for the first set of subsystems SUB-1A to SUB-1D (351-354) at Node A first power rail 331 and outputs O1-O4 (341-344). In this example, subsystems SUB-1A to SUB-1D (351-354) can be the back-up or redundant system during a power failure to control vehicle 100 to a safe stop. In this way, outputs O5-O9 (345-349) that are broken are isolated from other outputs in the power control system 300.

### Isolation Switch with Two Switch Example

FIG. 3B illustrates one example block diagram of detailed components of a power control system 390 having an isolation switch 307 with two power switches SW1 316-1 and SW2 316-2. For this example, isolation switch 307 uses one power rail 331 coupled to ten outputs O1-O10 (341-350). SW1 316-1 and SW2 316-2 include FET transistors to open or close a connection. Isolation switch 307 has an input I1 314 coupled to DC-DC converter 311 and an input I2 315 coupled to 12V battery 312. DC-DC converter 311 and 12V battery 312 can operate in the same manner as in FIG. 3A.

Referring to FIG. 3B, a first sensing resistor R1 317 and the first power switch SW1 316-1 are coupled to input I1 314 and a second sensing resistor R2 318 and the second power switch SW2 316-2 are coupled input I2 315. The μcontroller 370 can sense current from the first and second sensing resistors R1 and R2 (317, 318) or voltage across R1 and R2 or at the power rail 311 to detect a power failure to DC-DC converter 311 or 12V battery 312 as disclosed, e.g., in FIG. 6B. The output of SW2 316-2 is coupled to the output of SW1 316-1, which are both connected to the power rail 331, which is coupled to fuses 314. Fuses 314 includes a plurality of fuses having a corresponding fuse connected to respective outputs O1-O10 (341-350) and can operate in the same manner as fuses 314 in FIG. 3A.

For one example, outputs O1-O10 (31-350) are coupled to a plurality of subsystems SUB-1 to SUB-10 (351-360) which can be subsystems to control functions of vehicle 100 such as such as front and rear braking, autonomous driving (AD), ignition control, steering, dynamic stability, motion or movement sensors, and other vehicle functions. For one example, in operation, for power system 390, SW1 316-1 is closed (turned on) and SW2 316-2 is open (turned off) in which power from DC-DC converter 311 is passing through to power rail 331 and outputs O1-O10 (341-350) to subsystems SUB-1 to SUB-10 (351-360). Because SW2 316-2 is open or turned off, the 12V battery 312 is not providing power to the subsystems SUB-1 to SUB-10 (351-360). For one example, the μcontroller 370 can sense a power failure to DC-DC converter 311 if current passing through the first resistor R1 317 reaches or exceeds a threshold or a voltage across resistor R1 317 or at power rail 331 coupled to R1 reaches or is below a threshold. For other examples, vehicle gateway 150 can inform the μcontroller 370 that a power failure has occurred at DC-DC converter 311 by other sensing components.

For one example, in the event of a power failure to DC-DC converter 311, the μcontroller 370 can open SW1 316-1 (turned off) such that DC-DC converter 311 is isolated from the power rail 331 and can close SW2 316-2 (turned on) and allow power from 12V battery 312 to pass to the power rail 331 and to outputs O1-O10 (341-350) and to subsystems 351-360, 362 and 372. For power control system 390, each of the subsystems can receive auxiliary power from 12V battery 312 to control vehicle 100 to a safe stop. In addition, if current surging through power rail 331 that reaches or exceeds a threshold, fuses 314 can open and break a connection to the outputs O1-O10 (341-351) and corresponding subsystems. In this way, the connections to outputs O1-O10 (341-350) that are broken can be isolated from other outputs in the power control system 390 that are not broken.

For another example, 12V battery 312 is supplying power to the subsystems SUB-1 to SUB-10 (351-360) through isolation switch 307. The μcontroller 370 can detect a power failure to the 12V battery 312 by sensing current from the second sensing resistor R2 318 reaching or exceeding a threshold or a voltage reaching or below a threshold across R2 or at power rail 311 coupled to R2. If the μcontroller 370 detect a power failure, the μcontroller 370 can open (turned off) SW2 316-2 and close (turned on) SW1 316-1 and allow power from DC-DC converter 311 to pass to power rail 331 and to outputs O1-O10 (341-350) and to subsystems SUB-1 to SUB-10 (351-360) to control vehicle 100 to a safe stop.

Referring to FIGS. 3A-3B, the isolation switch 307 can be a single module to provide redundant or auxiliary low voltage power to subsystems including critical subsystems or redundant or back-ups of the critical subsystems as described above during a power failure without needing separate power systems for each redundant power supply. In this way, for example, critical subsystems such as AD driving, steering, braking, airbag and lighting control can operate to drive vehicle 100 to safe stop during a power failure to any of the low voltage power supplies. Isolation switch 307 can also isolate outputs and subsystems from a failed low voltage power supply by way of SW1 and/or SW2 and fuses to the outputs. In addition, by having fuses to the outputs within the isolation switch 307, separate fuse boxes for the DC-DC converter 311 and 12V battery 312 can be avoided. Additionally, in the above examples, the power control system 300 and 390 can be configured to switch power between the DC-DC converter 311 and 12V battery 312 within, e.g., milliseconds, before an internal capacitance storage in the subsystems and vehicle gateway 157 is depleted. This allows power to be maintained in the subsystems and vehicle gateway 157 if power from any of the low voltage power supplies is temporarily disabled to them prior to switch over. In this way, any lag time between switching between DC-DC converter 311 and 12V battery 312 does not affect operation of the subsystems or vehicle gateway 157 during the switch over.

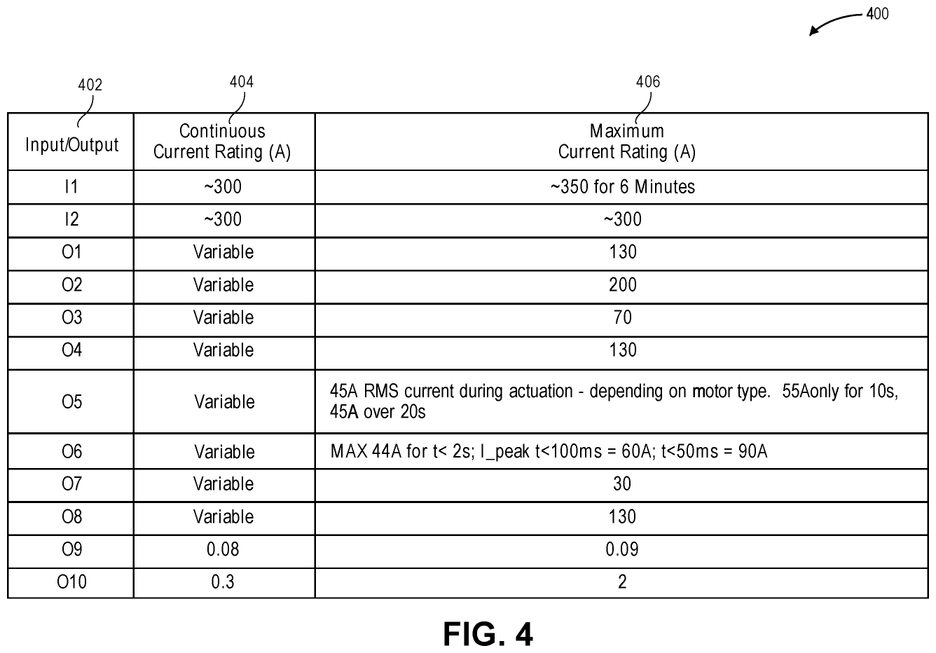

FIG. 4 illustrates one example of a current table 400 for the inputs and outputs of a power control system such as those shown in FIGS. 3A-3B. Table 400 includes columns 402, 404 and 406. Column 402 identifies two inputs I1 and I2 and ten outputs O1-O10. Column 404 lists exemplary continuous current ratings in amps (A) for the inputs I1-I2 and outputs O1-O10. Column 406 lists exemplary maximum current ratings in amps (A) for inputs I1-I2 and outputs O1-O10. For one example, columns 402 and 404 identify inputs I1 and I2 having a continuous current rating of approximately 300 A from DC-DC converter 311 and 12V battery 312 which is the allowable continuous current through inputs I1 and I2.

For one example, outputs O1-O8 can have a variable continuous current rating and outputs O9 and O10 can have a continuous current rating of 0.08 A and 0.3 A which is the allowable continuous current for those outputs. Column 406 identifies the maximum current rating which is the maximum amount of current allowed for the inputs I1 and I2 and outputs O1-O10 before a fuse breaks a connection. For one example, the μcontroller of the isolation switch detect if the current passing through inputs I1 and I2 and sensing resistors R1 and R2 reaches and exceeds the continuous or maximum current rating in column 404 to switch between low voltage power supplies. The fuses in the isolation switch can also break connections to the outputs O1-O10 if the maximum current rating is reached or exceeded in column 406. Although current table 400 refers to current values, voltage values can also be used to determine voltage ratings for inputs I1 and I2 outputs O1-O10.

### Exemplary Isolation Switch Operations

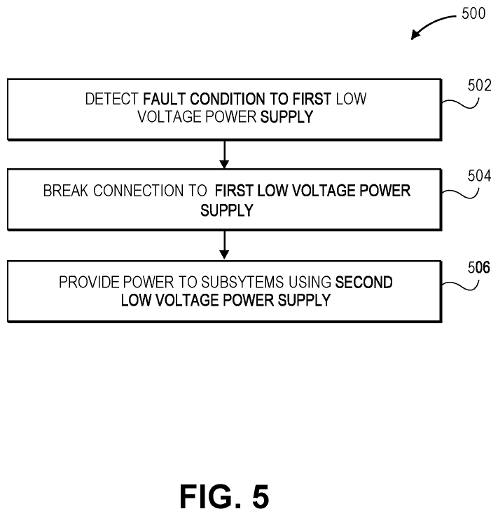

FIG. 5 illustrates one example flow diagram of an isolation switch operation 500. Operation 500 includes operations 502 through 510 and can be implemented by isolation switch 107, 207 and 307 of FIGS. 1A-3B.

At operation 502, a fault condition to a first low voltage power supply is detected. For example, isolation switch 107, 207 and 307 can detect a power failure to a DC-DC converter based on a current value reaching or exceeding a threshold value or a voltage value reaching or being below a threshold value.

At operation 504, a connection to the first low voltage power is broken. For example, isolation switch 107, 207 and 307 can turn off one or more power switches to disconnect the DC-DC converter to the outputs of the isolation switch that are coupled to subsystems of a vehicle, e.g., as disclosed in FIGS. 3A-3B. Additionally, fuses coupled to outputs of the isolation switch can break connections if current reaches or exceeds a threshold passing through the fuse.

At operation 506, a connection from the first low voltage power supply is switched to a second low voltage power supply. For example, isolation switch 107, 207 and 307 can turn on a power switch to switch the connection from the DC-DC converter to the 12V battery and the outputs of the isolation switch coupled to the subsystems.

At operation 508, the second low power voltage supply can be isolated from the first low voltage power supply. For example, isolation switch 107, 207 and 307 can separate the 12V battery from the DC-DC converter by preventing the DC-DC converter to be coupled to the same power rail.

At operation 510, power is provided to the subsystems using the second low voltage power supply. For example, isolation switch 107, 207 and 307 outputs power from the 12V battery to the subsystems of the vehicle. For the above operation 500, the first low voltage power supply can be the 12V battery and the second low voltage battery can be the DC-DC converter.

FIG. 6A illustrates one example flow diagram of an operation 600 for an isolation switch with one power switch. Operation 600 includes operations 602 through 612 and can be implemented by isolation switch 307 of FIG. 3A.

At operation 602, switch SW1 316 is off and a current or voltage from input I1 314 to the subsystems is measured. For example, μcontroller 370 can sense current passing through first sensing resistor R1 317 or a voltage across R1 or at a node coupled to R1. In addition, the μcontroller 370 can also sense current passing through the second sensing resistor R2 318 or a voltage across R2 or at a node coupled to R2 when switch SW1 316 is on at input I2 315.

At operation 604, the μcontroller 370 can detect if the current value reaches or exceeds a current threshold I_{thrshld} or the voltage value reaches or is below a voltage threshold V_{thrshld}. For example, such threshold values can be based on values in the table of FIG. 4. If no, operation 600 returns to operation 602. If yes, there is a power failure to the first low voltage power source such as DC-DC converter 311 and operation 600 proceeds to operation 606.

At operation 606, the SW1 is open or turned off. For example, μcontroller 370 can open or turn off SW1 316 so that the DC-DC converter 311 is disconnected and isolated from the second power rail 322 at Node B. When SW1 is open, 12V battery 312 delivers power through isolation switch 312 to outputs O5-O9 and the second set of subsystems SUB-2A to SUB-2E (355-359) during a power failure in order to drive vehicle 100 to a safe stop.

At operation 608, the status of SW1 is sent to the vehicle gateway. For example, μcontroller 370 can send a message to vehicle gateway 150 informing it that a power failure occurred and that SW1 is open or turned off and to inform other subsystems of vehicle 100. For the above operation 600, the first low voltage power supply can be the 12V battery and the second low voltage battery can be the DC-DC converter.

FIG. 6B illustrates one example flow diagram of an operation for an isolation switch having two power switches. Operation 620 includes operations 622 through 628 and can be implemented by isolation switch 307 of FIG. 3B.

At operation 622, switch SW1 316-1 is on and a current or voltage from input IL1 314 to the subsystems is measured. For example, μcontroller 370 can sense current passing through first sensing resistor R1 317 or a voltage across R1 or at a node coupled to R1. In addition, when switch SW1 316-1 is off and switch SW2 316-2 is on, the μcontroller 370 can also sense current passing through the second sensing resistor R2 318 or a voltage across R2 or at a node coupled to R2 from input I2 315.

At operation 624, the μcontroller 370 can detect if the current value reaches or exceeds a current threshold I_{thrshld} or the voltage value reaches or is below a voltage threshold V_{thrshld}. For example, such threshold values can be based on values in the table of FIG. 4. If no, operation 620 returns to operation 622. If yes, there is a power failure to the first low voltage power source such as DC-DC converter 311 and operation 620 proceeds to operation 626.

At operation 626, the SW1 is open or turned off and SW2 is turned-on or closed. For example, μcontroller 370 can open or turn off SW1 316-1 so that the DC-DC converter 311 is disconnected and isolated from the power rail 331 and turn-on or close SW2 such that 12V battery 312 is coupled to power rail 311 and providing power to subsystems SUB-1 to SUB-10 (351-360).

At operation 628, the status of SW1 and SW2 is sent to the vehicle gateway 150. For example, μcontroller 370 can send a message to vehicle gateway 150 informing it that a power failure occurred and that SW1 316-1 is open or turned off and SW2 316-2 is closed or turned on.

### Exemplary Vehicle Network Subsystem Nodes

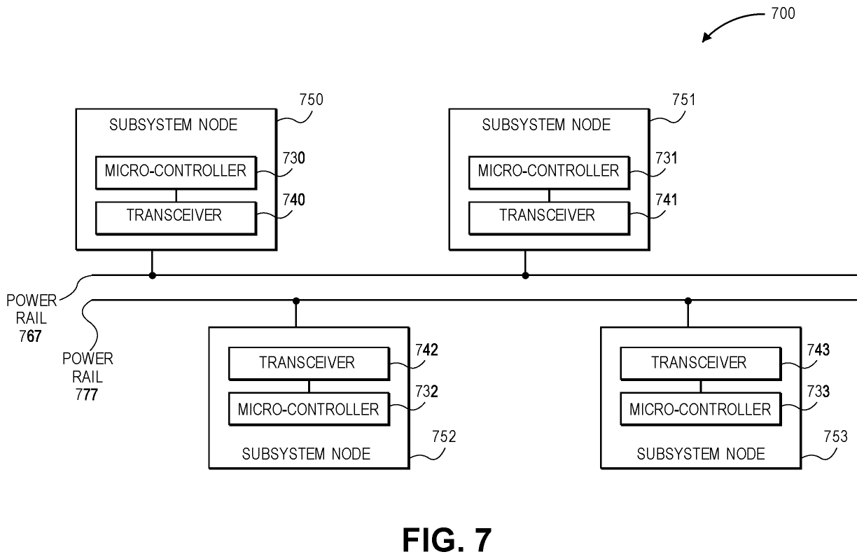

FIG. 7 illustrates one exemplary block diagram of a vehicle network 700 coupling subsystem 750-753 to power rails 767 and 777. Although four subsystem nodes are shown, any number of subsystem nodes can be implemented for the vehicle network 700 and can represent isolation switches 107, 207 and 307 and network gateway 157. Each of the subsystem nodes 750-753 includes respective transceivers 730-753 and micro-controllers 740-743 or processors. Each of the transceivers 730-733 are coupled to the network bus 702, which can support any type of vehicle network such as controller area network (CAN), local interconnect network (LIN), or an Ethernet network. For one example, transceivers 730-753 can support data messaging according to the ISO 11898-1, ISO/AWI 17987-8 and IEEE 802.11 protocols. Micro-controllers 740-743 can control vehicle functions such as those described in FIGS. 2-3B and communicate with other subsystem nodes 750-753. Each of the subsystem nodes 750-753 can represent subsystems in FIGS. 2 and 3A-3B including isolation switch isolation switch 107, 207 and 307 of FIGS. 1A-3B.

For one example, each of the subsystem nodes 750-753 is coupled to a respective power rail 767 or 777. Power rails 767 and 777 can deliver power from low voltage power supplies such as a DC-DC converter or a 12V battery. For example, power rails 767 or 777 can be coupled to an isolation switch as disclosed in FIGS. 1A-3B that selectively couples power from either the DC-DC converter or 12V battery to the subsystem nodes 750-753 according to the techniques disclosed herein. The above embodiments and examples in FIGS. 1A-7 allows electric vehicles and, in particular, AD vehicles meet safety levels in case of a power failure and provide power to critical subsystems to allow the vehicle to drive to a safe stop.

In the foregoing specification, the invention has been described with reference to specific exemplary embodiments thereof. It will, however, be evident that various modifications and changes may be made thereto without departing from the broader spirit and scope of disclosed embodiments and examples. The specification and drawings are, accordingly, to be regarded in an illustrative rather than a restrictive sense.

1. A power control system for a vehicle comprising:
first and second low voltage power supplies capable of providing power to a plurality of subsystems; and
an isolation switch configured to receive inputs from the first and second low voltage power supplies and to selectively output power from either of the first and second low voltage power supplies to the plurality of subsystems on at least one power rail.

2. The power control system of claim 1, wherein if a power failure occurs to one of the first and second low voltage power supplies, the isolation switch selectively outputs power to subsystems considered critical to maintaining operation of the vehicle.

3. The power control system of claim 2, wherein the subsystems considered critical to maintaining operation of the vehicle include autonomous driving, steering, braking, airbag and lighting subsystems.

4. The power control system of claim 1, wherein the isolation switch is configured to output power from either the first and second voltage power supplies to one group of the plurality of subsystems as a main group of subsystems and to switch output power from the main group to another group of the plurality of subsystems as backup subsystems of the main group.

5. The power control system of claim 1, wherein the first low voltage power supply is a direct current-to-direct current (DC-DC) converter and the second low voltage power supply is a rechargeable battery.

6. The power control system of claim 5, wherein the isolation switch is further configured to isolate the DC-DC converter from the rechargeable battery if there is a power failure to the DC-DC converter and switch connection of the plurality of subsystems to the rechargeable battery.

7. The power control system of claim 5, wherein the isolation switch is further configured to isolate the rechargeable battery from the DC-DC converter if there is a power failure to the rechargeable battery and switch connection of the plurality of subsystems to the DC-DC converter.

8. The power control system of claim 5, wherein the DC-DC converter receives power from a main high voltage power supply and recharges the rechargeable battery.

9. The vehicle power control system of claim 1, wherein the isolation switch comprises:
one or more sensors;
one or more power switches; and
a micro-controller coupled to the one or more power switches and one or more sensors, the micro-controller configured to detect a power failure using the one or more sensors and to control the one or more power switches in order to selectively output power from either the first low voltage power supply and the second low voltage power supply to the plurality of subsystems.

10. The vehicle power control system of claim 9, wherein the micro-controller breaks a connection from one of the first low voltage power supply or second low voltage power supply if a power failure is detected.

11. The vehicle power control system of claim 1, further comprising:
a plurality of fuses, each fuse corresponding to one of the plurality of components and to decouple the corresponding component from the first low voltage power supply or second low voltage power supply if a current reaches a threshold through the fuse.

12. The vehicle power control system of claim 1, wherein each component includes an electronic control unit (ECU) to control a subsystem of the vehicle and each component is coupled to a controller area network (CAN), local interconnect network (LIN), or an Ethernet network.

13. A vehicle comprising:
a plurality of subsystems;
an electric motor;
a main high voltage power supply coupled to the electric motor and to provide power to the electric motor;
a first low voltage power supply coupled to the main high voltage power supply capable of providing power to the plurality of subsystems
a second low voltage power supply capable of providing power to the plurality of subsystems; and
an isolation switch configured to receive inputs from the first and second low voltage power supplies and to selectively output power from either of the first and second low voltage power supplies to the plurality of subsystems on at least one power rail.

14. The vehicle of claim 13, wherein if a power failure occurs to one of the first or second low voltage power supplies the isolation selectively outputs power to subsystems considered critical to maintain operation of the vehicle.

15. The vehicle of claim 14, wherein the subsystems considered critical to maintain operation of the vehicle includes autonomous driving, steering, braking, airbag and lighting subsystems.

16. The vehicle of claim 13, wherein the main high voltage power supply is a rechargeable battery, the first low voltage power supply is a direct current-to-direct current (DC-DC) converter, and the second low voltage power supply is a rechargeable battery.

17. The vehicle of claim 16, wherein the isolation switch is further configured to isolate the DC-DC converter from the rechargeable battery as the second low voltage power supply if there is a power failure to the DC-DC converter and switch connection of the plurality of subsystems to the rechargeable battery as the second low voltage power supply.

18. The vehicle of claim 16, wherein the isolation switch is further configured to isolate the rechargeable battery as the second low voltage power supply from the DC-DC converter if there is a power failure to the rechargeable battery as the second low voltage power supply and switch connection of the plurality of subsystems to the DC-DC converter.

19. The vehicle of claim 16, wherein the DC-DC converter is to receive power from the rechargeable battery as the main high voltage power supply to charge the rechargeable battery as the second low voltage power supply.

20. The vehicle of claim 13, wherein the isolation switch comprises:
one or more sensors;
one or more power switches; and
a micro-controller coupled to the one or more power switches and one or more sensors, the micro-controller configured to detect a power failure using the one or more sensors and to control the one or more power switches in order to selectively output power from either the first low voltage power supply and the second low voltage power supply to the plurality of subsystems.

21. The vehicle of claim 20, wherein the micro-controller breaks a connection from one of the first low voltage power supply or second low voltage power supply if a power failure is detected.

22. The vehicle of claim 13, further comprising:
a plurality of fuses, each fuse corresponding to one of the plurality of components and to decouple the corresponding component from the first low voltage power supply or second low voltage power supply if a current reaches a threshold through the fuse.

23. The vehicle of claim 10, wherein each component includes an electronic control unit (ECU) to control a subsystem of the vehicle and each component is coupled to a controller area network (CAN), local interconnect network (LIN), or an Ethernet network.

24. The vehicle of claim 18, further comprising:
a network topology supporting the CAN, LIN or Ethernet network.

25. The vehicle of claim 19, further comprising:
a vehicle gateway coupled to each of the plurality of subsystems using the network topology to facilitate communication between the subsystems.

26. A method for an electric powered vehicle comprising:
detecting a power failure to a first low voltage power supply providing power to a plurality of subsystems of the electric powered vehicle;
breaking a connection from the first low voltage power supply to the plurality of subsystems; and
switching connection from the first low voltage power supply to a second low voltage power supply to provide power to the plurality of subsystems wherein second low voltage power supply is electrically isolated from the first low voltage power supply.

27. The method of claim 26, wherein detecting a power failure further comprises:
measuring a current or voltage to the plurality of subsystems;
determining if the measured current is at or above a current threshold or measured voltage is at or below a voltage threshold; and
opening a first switch from a closed state if the measured current is at or above the current threshold or the measured voltage is at or below a voltage threshold.

28. The method of claim 27, further wherein detecting a power failure further comprises closing a second switch from an open state.

29. The method of claim 28, wherein the first low voltage power supply is electrically isolated from the second low voltage power supply selectively opening and closing the first or second switches.

30. The method of claim 28, further comprising:
sending a status of the first switch or second switch to a gateway of the electric powered vehicle.
